(19) United States
(12) Patent Application Publication
(10) Pub. No.: US 2026/0012705 A1
(43) Pub. Date: Jan. 8, 2026

(54) MAGNETIC DEVICE FOR A SENSOR DEVICE, SENSOR DEVICE AND METHOD FOR PRODUCING A MAGNETIC DEVICE

(71) Applicant: Robert Bosch GmbH, Stuttgart (DE)

(72) Inventors: Frank Schatz, Kornwestheim (DE); Jochen Reinmuth, Reutlingen (DE); Philipp Matthias Roming, Schramberg (DE)

(21) Appl. No.: 19/252,114

(22) Filed: Jun. 27, 2025

(30) Foreign Application Priority Data
Jul. 2, 2024 (DE) 10 2024 206 192.1

(51) Int. Cl. H04N 23/68; H04N 23/54

(52) U.S. Cl. CPC H04N 23/687; H04N 23/54

(57) ABSTRACT

A magnetic device for a sensor device. The magnetic device includes a substrate unit designed as a micromechanical electrical system (MEMS), which includes a fixing portion, a movable motion portion, and a spring portion. The fixing portion and the motion portion are connected to one another via the spring portion. The magnetic device further includes magnetic elements arranged in the motion portion and a circuit board. The fixing portion is fixed to the circuit board. The circuit board includes a first conductor track circuit and a second conductor track circuit opposite the motion portion. The conductor track circuits, in the powered state, in each case generate a magnetic field interacting with at least some of the magnetic elements to effect a translational deflection of the motion portion in a first direction and in a second direction.

### CROSS REFERENCE

The present application claims the benefit under 35 U.S.C. § 119 of German Patent Application No. DE 10 2024 206 192.1 filed on Jul. 2, 2024, which is expressly incorporated herein by reference in its entirety.

### FIELD

The present invention related to a magnetic device for a sensor device, a sensor device, and a method for producing a magnetic device.

### BACKGROUND INFORMATION

There is a trend in camera modules, for example for smartphones, to replace the previous image stabilization based on a displacement of the lens with a displacement of the image chip. This displacement can be realized by so-called voice coil drives based on macroscopic magnets, precision mechanical spring elements and coils based on flex foil technology. Alternatively, so-called SMA (shape memory alloy) drives can be used, which are combined with mechanical spring elements. In both cases, the mechanical combination of drive and spring system leads to structures with tolerances that suggest high costs and low yield.

U.S. Pat. No. 11,274,033 B2 describes capacitive drive structures.

### SUMMARY

The present invention provides an improved magnetic device for a sensor device, an improved sensor device, and an improved method for producing a magnetic device. Advantageous developments and improvements of the device of the present invention are made possible by the measures disclosed herein.

The presented invention provides a way to combine a micromechanical electrical system (MEMS) with a powerful drive and thus achieve high accuracy. This can advantageously improve the accuracy of the spring system and thus the positioning, while simultaneously realizing contact. In this way, it is possible to react very flexibly and quickly and stabilize an image sensor.

The present invention provides a magnetic device for a sensor device. According to an example embodiment of the present invention, the magnetic device comprises a substrate unit designed as a micromechanical electrical system (MEMS), which comprises a fixing portion, a movable motion portion and a spring portion, wherein the fixing portion and the motion portion are connected to one another via the spring portion and wherein the motion portion comprises a coupling point for coupling to a sensor chip of the sensor device, further comprising a plurality of magnetic elements arranged in the motion portion. The magnetic device further comprises a circuit board that is arranged adjacent to the substrate unit, wherein the fixing portion is fixed to the circuit board. The circuit board comprises a first conductor track circuit and a second conductor track circuit opposite the motion portion, wherein the first conductor track circuit, in the powered state, generates a first magnetic field interacting with at least some of the plurality of magnetic elements in order to effect a translational deflection of the motion portion in a first direction. In the powered state, the second conductor track circuit generates a second magnetic field interacting with at least some of the plurality of magnetic elements in order to effect a translational deflection of the motion portion in a second direction.

The magnetic device of the present invention can advantageously be used in conjunction with a camera in order to advantageously make image stabilization possible. This means that the sensor device can be implemented as a camera, for example. The magnetic device can advantageously be designed as an actuator element of the sensor device. The substrate unit can, for example, be referred to as a carrier substrate. The spring portion, fixing portion and motion portion can advantageously be designed as one piece. The majority of magnetic elements can be polygonal, in particular square, but also rectangular. The rows in which the magnetic elements can be arranged can, for example, run parallel to one another and as a result form an array of magnetic elements. The magnetic elements can advantageously be arranged at an angle to one another. The circuit board can advantageously be a PCB circuit board that can, for example, evaluate sensor data. The substrate unit can advantageously be connected to the circuit board in a materially bonded manner, for example by gluing. The conductor track circuits in each case can be a winding of a coil that can be powered for generating a magnetic field that can interact with the magnetic fields of the magnetic elements. The conductor track circuits can be arranged in the circuit board in an electrically insulated manner. The first force generated in the powered state of the first conductor track circuit can advantageously act longitudinally to the rows and thus in the y-direction and the second force generated in the powered state of the second conductor track circuit can advantageously act in the x-direction, i.e., transversely to the rows.

According to one example embodiment of the present invention, the plurality of magnetic elements can be arranged in at least one first row and in at least one second row running adjacent to the first row. The magnetic elements of the first row can be equally polarized and the magnetic elements of the second row can be equally and oppositely polarized to the magnetic elements of the first row. The first conductor track circuit can run along the first row of magnetic elements and in the opposite direction along the second row of magnetic elements, wherein the second conductor track circuit can run in a meandering pattern between the rows. Due to the arrangement of the conductor track circuits, the accuracy of the image sensor can be advantageously improved.

The plurality of magnetic elements can be arranged in at least one row or only in a single row and can be alternately polarized, wherein the first conductor track circuit can run in a meandering pattern between the magnetic elements. The second conductor track circuit can run in a meandering pattern between the magnetic elements and, at least in the region of the plurality of magnetic elements, transversely or obliquely to the first conductor track circuit. With this arrangement of the conductor track circuits as well, image stabilization can advantageously be improved.

Furthermore, the plurality of magnetic elements can be arranged in a field of an alternating sequence of a first row and a second row running adjacent to the first row, wherein the magnetic elements of the first row can be alternately polarized and the magnetic elements of the second row can be alternately polarized and oppositely polarized to the magnetic elements of the first row. Portions of the first conductor track circuit spanning the field can run at an angle to the rows in one direction and an opposite direction, and portions of the second conductor track circuit spanning the field can run transversely or obliquely to the portions of the first conductor track circuit in one direction and an opposite direction. Advantageously, stabilization of the sensor chip or image stabilization can be improved.

The conductor tracks of the conductor track circuits can be made of copper. Due to the selection of the appropriate material for the conductor track circuits, electrical resistance can be kept as low as possible.

According to one example embodiment of the present invention, the conductor track circuits in each case can comprise a plurality of conductor tracks running parallel to one another. The plurality of parallel conductor tracks can form a plurality of windings. The size and shape of the generated magnetic field can be adjusted by the number of conductor tracks.

The substrate unit can comprise a main layer, an oxide layer and a silicon layer. For example, the main layer can contain silicon, just like the silicon layer. The layers can advantageously be of different thicknesses.

The main layer can form the spring portion. Alternatively, the oxide layer and the silicon layer can form the spring portion. Advantageously, the spring portion can effect image stabilization.

According to one example embodiment of the present invention, the magnetic device can comprise a flux guiding element, which can be arranged on a side of the plurality of magnetic elements facing away from the circuit board. This can advantageously bridge an air gap. The flux guiding element can advantageously comprise a ferromagnetic material. The flux guiding element can advantageously achieve a maximum field and improved robustness.

Furthermore, a sensor device is presented which comprises a magnetic device in an above-mentioned variant of the present invention and a sensor chip that is coupled to the magnetic device at the coupling point.

The sensor device can advantageously be designed as part of a camera. Advantageously, the magnetic device can be realized as an actuator element of the sensor device in order to be able to effect image stabilization.

According to one example embodiment of the present invention, the sensor device can comprise at least one bonding wire for electrically coupling the magnetic device and the sensor chip. Advantageously, the sensor chip can be powered via the bonding wire. More specifically, the bonding wire can be coupled to the circuit board. Additionally or alternatively, according to an example embodiment of the present invention, the sensor device can comprise a plurality of bonding wires that, for example, can electrically connect the circuit board and the sensor chip via an intermediate coupling point. For example, the intermediate coupling point can be arranged at the fixing portion of the substrate unit.

Furthermore, the sensor device can comprise a further magnetic device in an above-mentioned variant of the present invention, wherein the sensor chip can be coupled to the further magnetic device at a further coupling point. Advantageously, the sensor chip can be arranged so that it can move freely above the circuit board. The two magnetic devices can advantageously be arranged on opposite sides of the sensor chip. Advantageously, the circuit board can therefore comprise further conductor track circuits that can interact with further magnetic elements of the further magnetic device.

A method for producing a magnetic device in an above-mentioned variant of the present invention is also provided. According to an example embodiment of the present invention, the method comprises a step of providing a substrate unit that comprises a fixing portion, a movable motion portion and a spring portion, wherein the fixing portion and the motion portion are connected to one another via the spring portion, a plurality of magnetic elements and a circuit board that comprises a first conductor track circuit and a second conductor track circuit. The method further comprises a step of arranging the plurality of magnetic elements in the motion portion of the substrate unit, for example in a first row and in a second row running adjacent to the first row. The magnetic elements in the first row have the same polarity and the magnetic elements in the second row have the same and opposite polarity to the magnetic elements in the first row. Furthermore, the circuit board is arranged adjacent to the substrate unit and opposite to the motion portion, wherein the first conductor track circuit runs, for example, along the first row of magnetic elements and runs in the opposite direction along the second row of magnetic elements in order to effect a first force on the motion portion in the powered state. The second conductor track circuit, for example, runs in a meandering pattern between the rows in order to effect a second force on the motion portion. The method further comprises a step of fixing the fixing portion to the circuit board.

According to one example embodiment of the present invention, in the step of arranging, the magnetic elements can be arranged as a magnetic mass in the motion portion, in particular by means of a raking process. Advantageously, a receiving region for receiving the magnetic elements in the substrate unit can be efficiently utilized.

Furthermore, according to an example embodiment of the present invention, the method can comprise a step of providing a raw substrate unit, which can comprise a main layer, an oxide layer and additionally or alternatively a silicon layer, and a step of structuring the raw substrate unit in order to be able to produce the substrate unit prior to the step of providing the substrate unit, the plurality of magnetic elements and the circuit board. Advantageously, the three portions of the substrate unit can be formed by structuring. This can advantageously be carried out simultaneously or sequentially.

According to an example embodiment of the present invention, the step of structuring can comprise a first sub-step for jointly structuring the oxide layer and the silicon layer and a second sub-step for subsequently structuring the main layer in order to be able to produce the substrate unit prior to the step of providing the substrate unit, the plurality of magnetic elements and the circuit board, wherein, in the step of arranging, the plurality of magnetic elements can be arranged in the structured main layer and the circuit board can be arranged adjacent to the substrate unit and opposite to the motion portion. In the step of fixing, the fixing portion can be fixed to the circuit board.

Here, the method can comprise a step of attaching a sensor chip to a coupling point in the motion portion and at least one bonding wire for coupling the sensor chip to the circuit board. Advantageously, a receiving region for receiving the magnetic elements can be formed in the substrate unit, more precisely in the motion portion of the substrate unit, and the spring portion can be formed in the main layer.

Alternatively, in the step of providing, the raw substrate unit can be provided, which can comprise the main layer and the oxide layer. In the structuring step, the oxide layer can be structured. The method can comprise a step of applying a silicon layer after structuring the oxide layer and a further step of structuring the main layer and the silicon layer in order to be able to produce the substrate unit prior to the step of providing the substrate unit, the plurality of magnetic elements and the circuit board. Advantageously, a receiving region for receiving the magnetic elements can be formed in the substrate unit, more precisely in the motion portion of the substrate unit, and the spring portion can be formed in the silicon layer and the oxide layer.

Exemplary embodiments of the present invention are illustrated in the figures and explained in more detail in the following description.

### BRIEF DESCRIPTION OF THE DRAWINGS

FIG. 1 is a schematic representation of an exemplary embodiment of the sensor device, according to the present invention.

FIG. 2 is a schematic side representation of an exemplary embodiment of a sensor device, according to the present invention.

FIG. 3 is a schematic representation of an exemplary embodiment of a magnet arrangement of the magnetic elements, according to the present invention.

FIG. 4 is a schematic representation of an exemplary embodiment of a magnet arrangement of the magnetic elements, according to the present invention.

FIG. 5 is a schematic representation of an exemplary embodiment of a magnet arrangement of the magnetic elements, according to the present invention.

FIG. 6 is a schematic representation of an exemplary embodiment of a magnet arrangement of the magnetic elements, according to the present invention.

FIG. 7 is a schematic representation of an exemplary embodiment of a raw substrate unit, according to the present invention.

FIG. 8 is a schematic representation of an exemplary embodiment of a raw substrate unit, according to the present invention.

FIG. 9 is a schematic representation of an exemplary embodiment of a raw substrate unit, according to the present invention.

FIG. 10 is a schematic representation of an exemplary embodiment of a substrate unit, according to the present invention.

FIG. 11 is a schematic representation of an exemplary embodiment of the sensor device, according to the present invention.

FIG. 12 is a schematic representation of an exemplary embodiment of a raw substrate unit, according to the present invention.

FIG. 13 is a schematic representation of an exemplary embodiment of a raw substrate unit, according to the present invention.

FIG. 14 is a schematic representation of an exemplary embodiment of a raw substrate unit, according to the present invention.

FIG. 15 is a schematic representation of an exemplary embodiment of a raw substrate unit, according to the present invention.

FIG. 16 is a schematic representation of an exemplary embodiment of a raw substrate unit, according to the present invention.

FIG. 17 is a schematic representation of an exemplary embodiment of a raw substrate unit, according to the present invention.

FIG. 18 is a schematic representation of an exemplary embodiment of a substrate unit, according to the present invention.

FIG. 19 is a flow chart of an exemplary embodiment of a method for producing a magnetic device, according to the present invention.

FIG. 20 is a schematic representation of an exemplary embodiment of a magnet arrangement of the magnetic elements, according to the present invention.

FIG. 21 is a schematic representation of an exemplary embodiment of a magnet arrangement of the magnetic elements, according to the present invention.

### DETAILED DESCRIPTION OF EXAMPLE EMBODIMENTS

In the following description of advantageous exemplary embodiments of the present approach, the same or similar reference signs are used for the elements shown in the various figures and acting similarly, wherein a repeated description of these elements is omitted.

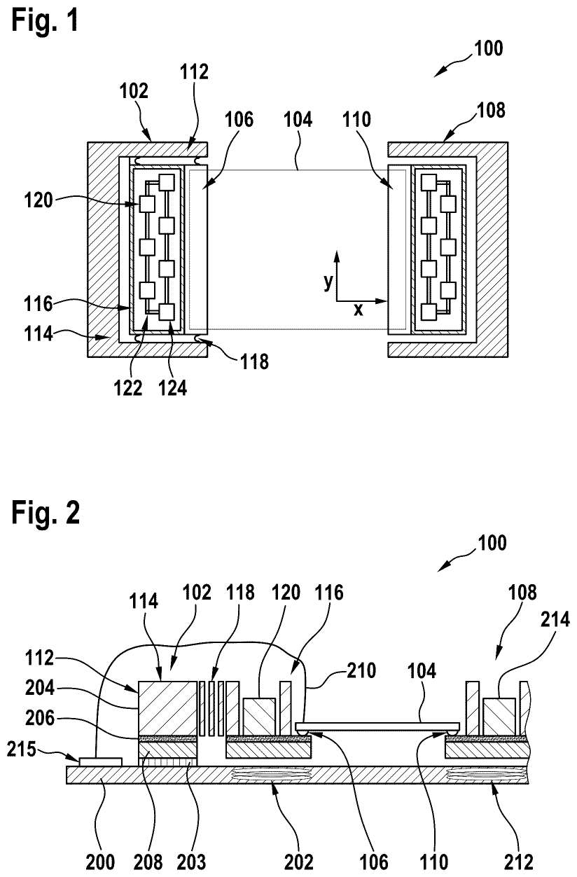

FIG. 1 is a schematic representation of an exemplary embodiment of a sensor device 100, as used for cameras, for example. The sensor device 100 comprises a magnetic device 102 and a sensor chip 104, which is coupled to the magnetic device 102 at a coupling point 106. The sensor chip 104 comprises, for example, an image sensor. In addition, the sensor device 100 according to this exemplary embodiment comprises a further magnetic device 108, which is similar in structure to the magnetic device 102. This means that the further magnetic device 108 also comprises a further coupling point 110, to which the sensor chip 104 is coupled. According to this exemplary embodiment, the two coupling points 106, 110 are located opposite one another. The magnetic devices 102, 108 make a movable mounting of the sensor chip 104 possible.

Advantageously, the sensor chip 104 can be moved and thereby stabilized using the magnetic devices 102, 108, here for example in the longitudinal direction and transverse direction, i.e. along a shown x-axis and a shown y-axis.

Here, the magnetic device 102 comprises a substrate unit 112 that comprises a fixing portion 114, a movable motion portion 116 and a spring portion 118. Here, the fixing portion 114 and the motion portion 116 are movably connected to one another via the spring portion 118. The magnetic device 102 also comprises a plurality of magnetic elements 120 arranged in the motion portion 116, which magnetic elements are arranged in a first row 122 and in a second row 124 running adjacent to the first row 122. The magnetic elements 120 are in each case aligned along a straight line in the rows 122, 124. This offers a space-saving arrangement and the magnetic elements 120 are easy to control. Alternatively, the magnetic elements 120 in the rows 122, 124 can be arranged, for example, alternately or otherwise offset from one another.

The magnetic elements 120 of the first row 122 are arranged with the same polarity and the magnetic elements 120 of the second row 124 are arranged with the same and opposite polarity to the magnetic elements 120 of the first row 122. For example only, the first row 122 comprises three magnetic elements 120 and the second row 124 comprises four magnetic elements 120.

The magnetic device 102 further comprises a circuit board running below the magnetic devices 102, 108 and the sensor chip 104, which circuit board is not shown in FIG. 1 due to the representation perspective and is instead described in more detail in FIG. 2. The circuit board is arranged adjacent to the substrate unit 112, wherein the fixing portion 114 is fixed to the circuit board. The circuit board comprises a first conductor track circuit and a second conductor track circuit opposite the motion portion, wherein the first conductor track circuit runs along the first row 122 of the magnetic elements 120 and runs in the opposite direction along the second row 124 of the magnetic elements 120 in order to effect a first force on the motion portion 116 in the powered state. The second conductor track circuit runs in a meandering pattern between the rows 122, 124 in order to effect a second force on the motion portion 116. The first force acts longitudinally to rows 122, 124 in the y-direction and the second force acts transversely to rows 122, 124 in the x-direction.

Accordingly, according to one exemplary embodiment, the circuit board comprises corresponding conductor track circuits opposite the magnetic device 108. As an alternative to a single-piece circuit board, a multi-piece circuit board can be used.

In other words, a magnetic drive unit for optical image stabilization is described. The magnetic device 102 can be described, for example, as an electrodynamic drive that can be integrated into a MEMS structure.

A magnetic drive consists of a magnetic system that generates a defined field and a system of conductor tracks that can be supplied with a defined current. Here, the basis of force transmission is the Lorentz force. The resulting force is the cross product of the field and the current multiplied by the length of the conductor in the field and the number of conductors (F=n*L*IxB). In order to achieve low power consumption, it is important that the conductor tracks do not have a high resistance. This requires the largest possible cross-section and a material with good conductivity. In principle, copper can also be used as a material in MEMS technology, but the cross-section is limited. It is therefore advisable to integrate the magnetic elements 120 and to accommodate the conductor tracks on, for example, standard circuit boards (power circuit board; PCB). On PCBs, conductor tracks with a few ohms are easy to realize.

MEMS is therefore a technology that is limited with respect to its dimension in the third spatial direction, for example perpendicular to the wafer. For example, a typical 6-inch wafer is about 700 μm thick. In such a case, the magnets therefore have only small dimensions in their thickness, for example 500 μm.

The total area of a MEMS actuator element is therefore preferably adapted to the task. For image stabilization, a sensor chip 104, also known as an imager chip, is used, which can have an edge length between 5 and 15 mm, for example. The available space for the MEMS chip and thus the magnetic device 102 is therefore, for example, of a similar size. In order to be able to use the actuator chip for any size, it is advisable to position the sensor chip 104 on at least two magnetic devices 102, 108 as individual actuators.

A movement clearance in such a system, or of the motion portion 116, is, for example, 100 μm in the x-direction and 100 μm in the y-direction. Due to an opposite movement of the two magnetic devices 102, 108 in the y-direction, merely by way of example, a rotation angle of 1.4° is achieved at a distance of 8 mm.

In other words, actuator elements, which are described here as magnetic devices 102, 108, are provided for stabilizing an image sensor, which magnetic devices, for example, comprise at least one (permanent) magnet and are mounted in a spring-elastic manner. The sensor chip 104, also referred to as a converter chip, is then arranged between these magnetic devices 102, 108, for example, wherein a movement of the magnetic devices 102, 108 is carried out by powering one or more coils which are embedded in a circuit board or arranged on this circuit board and which interact with the magnetic field of the magnets. In order to be able to impress a movement of the magnetic devices 102, 108 in a particularly flexible manner, according to this exemplary embodiment, a plurality of magnetic elements 120 are arranged in the form of an array on or in the corresponding magnetic devices 102, 108.

According to one exemplary embodiment, the described approach is based on the integration of magnets into a MEMS in order to be able to generate translational movements with high accuracy and high force. A corresponding production process is described below. The magnets can be arranged in special magnet designs suitable for generating the movement.

According to one exemplary embodiment, the magnetic devices 102, 108 represent an element to which the sensor chip 104 can be glued and contacted, so that it becomes movable. This element consists of a MEMS part having integrated magnets and a circuit board part that is used for power supply and relaying the contacts. This means that the substrate unit and magnets are produced in MEMS according to one exemplary embodiment, while the circuit board is produced in a different technology. The circuit board can also be a ceramic plate or a so-called MID. According to one exemplary embodiment, neither the entire sensor device 100 nor even the entire magnetic devices 102, 108 are produced in MEMS.

According to one exemplary embodiment, the substrate unit 112 is designed as a MEMS, since in one process variant, bond wires are still bonded to possible pads on the substrate, so that there is also an electrical aspect here.

FIG. 2 is a schematic side representation of an exemplary embodiment of a sensor device 100, which corresponds, for example, to the sensor device described in FIG. 1. Here as well, the sensor device 100 comprises the substrate unit 112 having the fixing portion 114, the movable motion portion 116 and the spring portion 118. The plurality of magnetic elements 120 are shown here in a simplified manner as a block. As already described in FIG. 1, the sensor device 100 comprises a circuit board 200 that is arranged adjacent to the substrate unit 112. Here, the fixing portion 114 is fixed to the circuit board 200. The circuit board 200 comprises, opposite the motion portion 116, the first conductor track circuit and the second conductor track circuit, which are formed, for example, as part of a coil 202. The first conductor track circuit runs along the first row of magnetic elements 120 and then back in the opposite direction along the second row of magnetic elements 120 in order to effect a first force on the motion portion 116 in the powered state. The second conductor track circuit runs in a meandering pattern between the rows in order to effect a second force on the motion portion 116. According to this exemplary embodiment, the substrate unit 112 is connected in a materially bonded manner to the circuit board 200 in the fixing portion 114, for example, glued using a connecting material 203.

Furthermore, the substrate unit 112 optionally comprises a main layer 204, an oxide layer 206 and a silicon layer 208. According to this exemplary embodiment, the layers 204, 206, 208 are arranged in the fixing portion 114 and in the motion portion 116. According to this exemplary embodiment, the main layer 204 forms the spring portion 118, which is structured in a spring shape. In an alternative embodiment, such as that described in FIG. 11, the oxide layer 206 and the silicon layer 208 can form the spring portion 118. Here, the oxide layer 206 is arranged between the main layer 204 and the silicon layer 208. Likewise, the oxide layer 206 is designed to be the thinnest of the three layers 204, 206, 208 and the main layer 204 is designed to be the thickest as the carrier layer.

According to this exemplary embodiment, the magnetic device 102 comprises the coupling point 106, at which the sensor chip 104 is arranged, for example coupled in a materially bonded manner. The sensor chip 104 is also referred to as a CIS sensor, for example. The magnetic device 102 further comprises at least one bonding wire 210 for electrically coupling the magnetic device 102 and the sensor chip 104. The bonding wire 210 is coupled to the sensor chip 104, for example, in the region of the coupling point 106. The bonding wire 210 can be realized in multiple parts only as an option.

As in FIG. 1, the sensor device 100 according to this exemplary embodiment comprises the further magnetic device 108, which in its structure corresponds, for example, to the magnetic device 102 and is therefore coupled to the sensor chip 104 via the further coupling point 110. The circuit board 200 comprises, for example, at least one further coil 212 having further conductor tracks that, analogous to the magnetic device 102, act in the powered state with a plurality of further magnetic elements 214 of the further magnetic device 108 and generate a force effect in two directions.

The magnetic device 102, also referred to as a MEMS element, and its assembly with the circuit board 200 are described in more detail below. For example, as the substrate unit 112, an SOI substrate such as a silicon on-insulator is used as a base. The main layer 204 serves, for example, as a base substrate for receiving the magnetic elements 120. For example, the spring portion 118 is simultaneously produced from the base substrate. In a favorable embodiment, partial regions of the main layer 204 can be completely filled with a magnet 120, as shown, for example, in FIG. 11. In this case, the thin silicon layer 208 is produced with particular precision with respect to thickness. This is used, for example, on the one hand as a lip and corresponds, for example, to the coupling point 106 on which the sensor chip 104 is anchored and, on the other hand, as a support for the magnetic elements 120. For both tasks, it is important that the thickness of the silicon layer 208 is small, the thickness has a small dispersion and the material properties of the silicon layer 208 are as homogeneous as possible.

According to this exemplary embodiment, the at least one bonding wire 210 for contacting the sensor chip 104 is pulled from the sensor chip 104 via the magnets 120 arranged, for example, laterally. Thus, long bond loops can be generated without requiring additional space on the circuit board 200. Long bond wires 210 are important so that a generally not well-defined spring force of the bond wires 210 is small compared to the well-defined springs formed from the main layer 204.

This combination is then glued to the circuit board 200. No adhesive is provided under the motion portion 116 and under the sensor chip 104, as a result of which these regions are kept movable. The contact surfaces 215 are provided in a region that is firmly glued to the circuit board 200, so that subsequently the at least one bonding wire 210 can be pulled from the contact point 106 to the circuit board 200 without any problems.

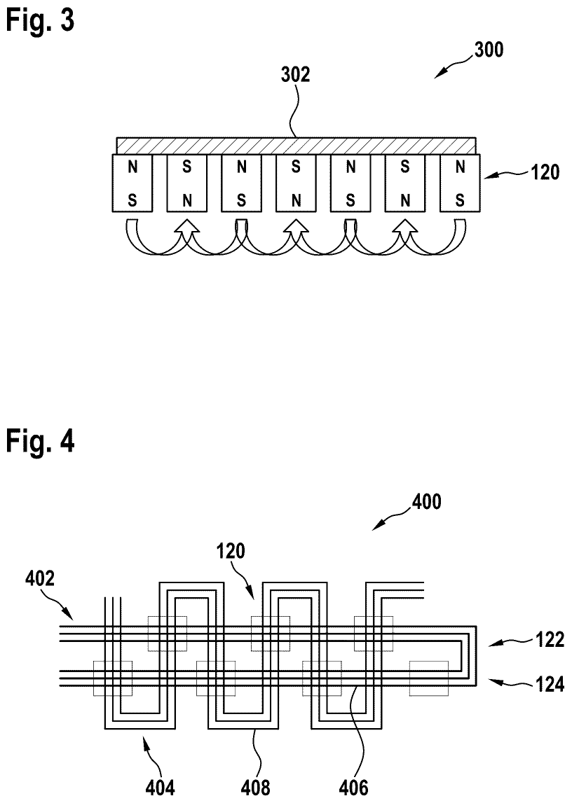

FIG. 3 is a schematic representation of an exemplary embodiment of a side view of a magnet arrangement 300 of the magnetic elements 120, which, for example, are similar to the magnetic elements described in at least one of FIGS. 1 to 2. According to this exemplary embodiment, the magnetic elements 120 are alternately polarized. In addition, the magnetic elements 120 are arranged with one side on a flux guiding element 302, which, for example, in the mounted state of the magnetic device is arranged facing away from the circuit board.

FIG. 4 is a schematic representation of an exemplary embodiment of a plan view of a magnet arrangement 400 of the magnetic elements 120, as described, for example, in at least one of FIGS. 1 to 2. As also described in FIG. 1, the magnetic elements 120 are arranged in two rows 122, 124. Furthermore, the conductor track circuits 402, 404 described in FIGS. 1 to 2 are shown, which run within the circuit board not explicitly shown here. According to this exemplary embodiment, the conductor track circuits 402, 404 are shown crossed, wherein they are electrically insulated from one another at these crossing points. As already described, the first conductor track circuit 402 initially runs along the first row 122 of the magnetic elements 120 and then back in the opposite direction along the second row 124 of the magnetic elements 120 in order to effect a first force on the motion portion in the powered state. The second conductor track circuit 404 runs in a meandering pattern between the rows 122, 124 in order to effect a second force on the motion portion.

According to this exemplary embodiment, the conductor track circuits 402, 404 in each case comprise a plurality of conductor tracks 406, 408 running parallel to one another, which are formed, for example, from copper. When the respective conductor tracks 406, 408 of a conductor track circuit 402, 404 are connected in parallel, the lowest possible electrical resistance can be realized, while when connected in series, the largest possible magnetic field can be achieved. The number of conductor tracks 406, 408 is optionally dependent on the shape or size of the magnetic elements 120.

In other words, an array of a plurality of magnetic elements 120 is shown, in which the magnetic elements 120 are alternately poled. The magnetic elements 120 are arranged in at least two rows 122, 124, wherein the magnetization of the magnetic elements 120 is oriented in the same way in each case within a row 122, 124. There are also at least two conductor track circuits 402, 404 arranged in such a way that the first conductor track 406 runs along the row 122 and then runs back in the opposite direction along the row 124. The force then acts in the y-direction. The second conductor tracks 408 run in a meandering pattern from row to row. The force is in the x-direction.

Through this array arrangement, the magnetic elements 120 stabilize each other. In principle, it is also possible to use a flux guide on the back side of the magnets, as described in FIG. 3, for example. For example, assuming a magnet size of 600 μm*600 μm*600 μm, three conductor tracks 406, 408 having a conductor track width of 75 μm and a conductor track spacing of 75 μm can be mounted next to one another and still have a good 100 μm of freedom of movement without leaving the magnet region. For example, with a distance of 400 μm, the total size of the magnet arrangement 400 is less than 8 mm to 3 mm, which corresponds to a preferred size. In order to position the magnetic elements 120 precisely, pockets are cut into a silicon structure, for example, into which the magnetic elements 120 are inserted, for example glued in place. The force generated by such a system with 21 crossing points is in the range of 100 μN. For a movement of 100 μm, for example, a stiffness of the system of 1 N/m is estimated. For a mass of 100 mg, wherein this mass is composed, for example, of 50 mg for the actuator, i.e. the magnetic device, and 50 mg for half of the sensor chip, a resonance frequency of 17 Hz results. However, the shape of the magnetic elements 120 can be realized in different ways. Due to rectangular magnets 120, as described for example in the following figure, the number of crossing points is increased, which increases the force but, depending on the implementation, also the required area.

According to one exemplary embodiment, the conductor tracks 406, 408 are meanders that are perpendicular or approximately perpendicular to one another in the region of the magnets, for example at an angle between 70° and 110°, for example at an 80° angle. Thus, by means of a suitable control, two directions of movement perpendicular to one another can be generated at intersection points of the conductor tracks 406, 408, even with angles deviating from 90°.

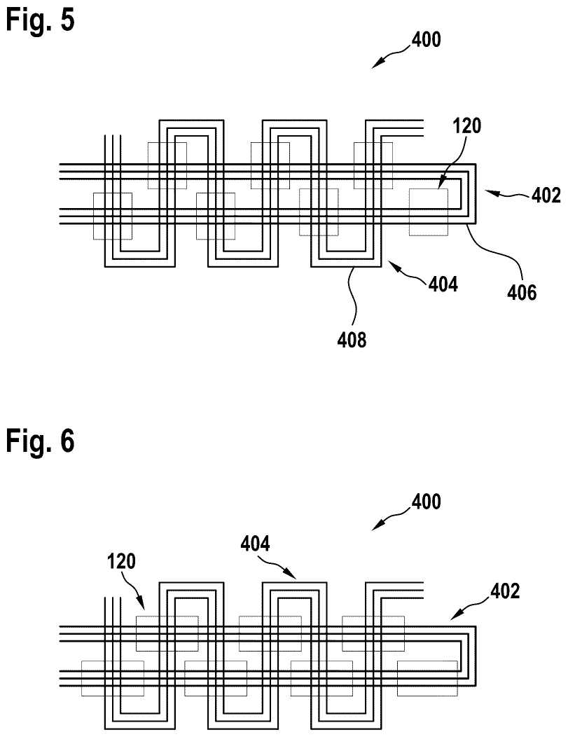

FIG. 5 is a schematic representation of an exemplary embodiment of the magnet arrangement 400 of the magnetic elements 120, as described or at least mentioned in at least one of FIGS. 1 to 5. Here, the magnet arrangement 400 corresponds to the magnet arrangement described in FIG. 4, wherein only the shape of the magnetic elements 120 and the number of conductor tracks 406 differ from it. According to this exemplary embodiment, the magnetic elements 120 are rectangular in shape, so that the two long sides thereof offer more area for the conductor track circuit 402 and thus the number of conductor tracks 406 is increased. Here, the main extension direction of the magnetic elements 120 runs transversely to the main extension direction of the first conductor track circuit 402.

FIG. 6 is a schematic representation of an exemplary embodiment of the magnet arrangement 400 of the magnetic elements 120, as described or at least mentioned in at least one of the FIGS. 1 to 5. Here, the magnet arrangement 400 corresponds to the magnet arrangement described in FIG. 4, wherein only the shape of the magnetic elements 120 differs from it. More precisely, the magnetic elements 120 are rectangular and arranged in such a way that their main extension direction runs along the main extension direction of the first conductor track circuit 402.

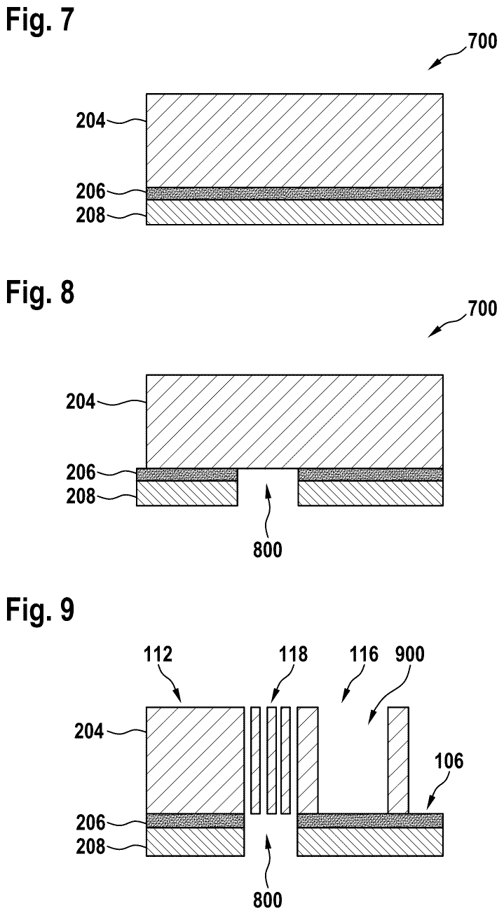

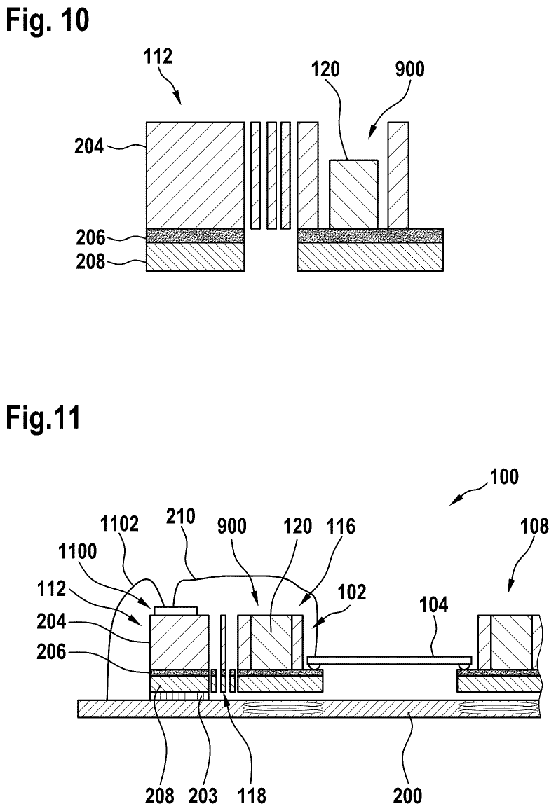

FIG. 7 is a schematic representation of an exemplary embodiment of a raw substrate unit 700, which is used to produce a substrate unit as described, for example, in at least one of FIGS. 1 and 2. Here, the raw substrate unit 700 comprises three layers 204, 206, 208, which are described as main layer 204, oxide layer 206 and silicon layer 208, as in FIG. 2. The oxide layer 206 is realized with the smallest thickness and is arranged between the main layer 204 and the silicon layer 208. More specifically, an initial state of the raw substrate unit 700 is shown, for example. More specifically, FIGS. 7 to 9 show steps for the production, or intermediate states during the production of the substrate unit, as described, for example, in FIG. 10.

FIG. 8 is a schematic representation of an exemplary embodiment of a raw substrate unit 700, which is similar, for example, to the raw substrate unit described in FIG. 7. According to this exemplary embodiment, it is shown in a processing state. This means that the raw substrate unit 700 according to this exemplary embodiment is shown in a partially structured manner. More specifically, the oxide layer 206 and the silicon layer 208 are structured in a common portion 800. The main layer 204 is untouched according to this exemplary embodiment.

FIG. 9 is a schematic representation of an exemplary embodiment of a substrate unit 112, as described, for example, in at least one of FIGS. 1 to 2. For example, the substrate unit 112 was produced using a raw substrate unit as described, for example, in at least one of FIGS. 7 to 8. In the region of the portion 800 of the oxide layer 206 and the silicon layer 208, the spring portion 118 is formed in the main layer 204. More specifically, after structuring the oxide layer 206 and the silicon layer 208, the main layer 204 was structured in order to form the spring portion 118. In addition, in the motion portion 116, a receiving region 900 was introduced into the main layer 204, in which, for example, the plurality of magnetic elements can be arranged, and the coupling point 106 for coupling with a sensor chip was realized. The coupling point 106 is formed as a projection.

FIG. 10 is a schematic representation of an exemplary embodiment of a substrate unit 112, as described, for example, in FIG. 9. According to this exemplary embodiment, at least one magnetic element 120 is additionally introduced into the pocket 900.

FIG. 11 is a schematic representation of an exemplary embodiment of a sensor device 100, which is similar, for example, to the sensor device described in at least one of FIGS. 1 to 2. According to this exemplary embodiment as well, the substrate unit 112 is divided into three portions 114, 116, 118, wherein according to this exemplary embodiment, in contrast to FIG. 2, the oxide layer 206 and the silicon layer 208 form the spring portion 118 and thus a spring element. In other words, this means that 208 springs are produced in the thin layer. Thus, for example, particularly torsion-type springs can be generated due to the reduced height, or particularly narrow and soft springs due to the lower aspect ratio.

In addition, the magnetic device 102 according to this exemplary embodiment comprises at least one contact surface 1100, which is formed as an intermediate contact for the at least one bonding wire 210. In other words, contact surfaces 1100 can also be provided on the thick substrate 204 in order to initially bring the bond wires 210 from the sensor chip 104 onto these surfaces 1100 and then to provide further bond wires 1102 from there to the circuit board 200. This is particularly advantageous for applications in which, in a first step, in each case two MEMS chips are combined with a sensor chip 104 and the first bond wires 210 are additionally attached. This can be carried out, for example, on a temporary carrier. Thus, particularly precise alignment of the chips with respect to one another can be achieved, and since the two MEMS chips lie fully on the carrier in this state, a bonding wire can also be placed on the CIS chip without any problems.

According to this exemplary embodiment, the at least one magnetic element 120 fills a receiving region 900, which is similar to the receiving region described in FIG. 9, for example, for receiving the magnetic elements 120 and is therefore precisely adapted to a depth of the receiving region 900. The further magnetic device 108 also corresponds to the magnetic device 102 in FIG. 11.

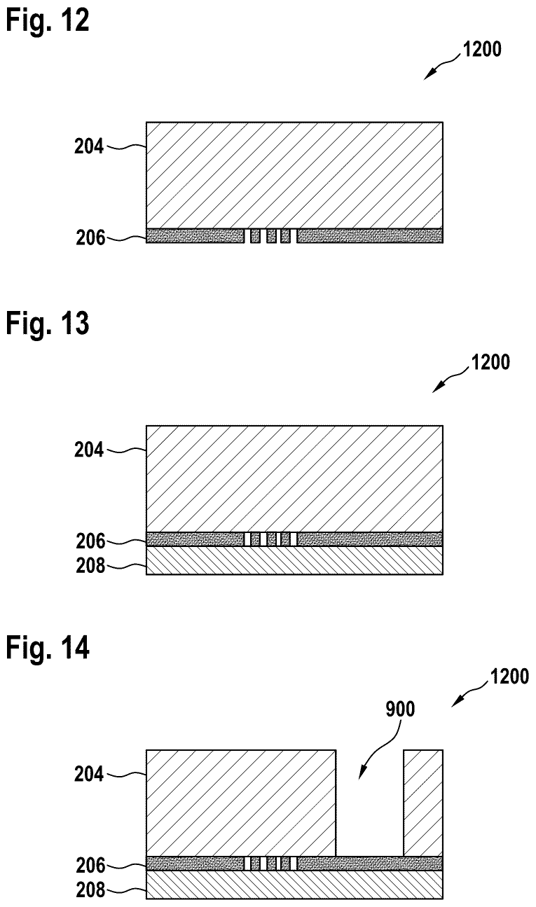

FIG. 12 is a schematic representation of an exemplary embodiment of a raw substrate unit 1200, which is similar, for example, to that in at least one of FIGS. 7 to 8. According to this exemplary embodiment, the raw substrate unit 1200 initially comprises the main layer 204 and the oxide layer 206, wherein the latter is structured.

FIG. 13 is a schematic representation of an exemplary embodiment of a raw substrate unit 1200, which, for example, corresponds to or is similar to the raw substrate unit described in FIG. 12. According to this exemplary embodiment, the silicon layer 208 was additionally applied to the raw substrate unit 1200, so that the oxide layer 206 is arranged between the main layer and the silicon layer 208. More specifically, FIGS. 13 to 18 show steps for producing, or intermediate states during the production of the substrate unit, as described, for example, in FIG. 11.

FIG. 14 is a schematic representation of an exemplary embodiment of a raw substrate unit 1200, which, for example, corresponds to or is similar to the raw substrate unit described in one of FIGS. 12 to 13. In addition to the raw substrate unit described in FIG. 13, the raw substrate unit 1200 according to this exemplary embodiment was structured in order to form a receiving region 900 for receiving at least one magnetic element. The receiving region 900 corresponds, for example, to the receiving region described in FIG. 9 and is designed as a recess here.

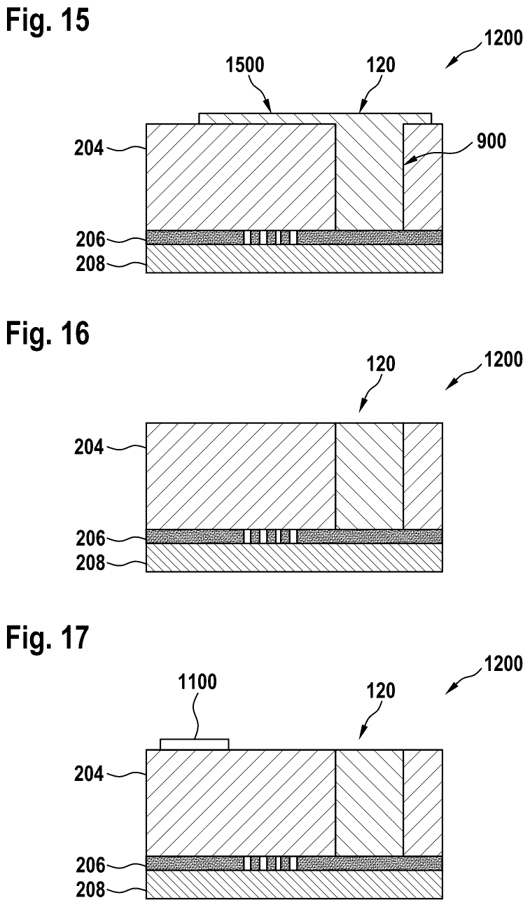

FIG. 15 is a schematic representation of an exemplary embodiment of a raw substrate unit 1200, as described, for example, in at least one of FIGS. 12 to 14. According to this exemplary embodiment, at least one magnetic element 120, which is also described as a magnetic mass, is arranged in the receiving region 900 and completely fills it. More specifically, FIG. 15 shows an excess 1500 of magnetic mass protruding from the receiving region 900 and covering a large part of the main layer 204.

FIG. 16 is a schematic representation of an exemplary embodiment of a raw substrate unit 1200, as described, for example, in at least one of FIGS. 12 to 15. According to this exemplary embodiment, a difference to FIG. 15 is shown here, since the excess magnetic mass has been removed. The magnetic element 120 forms a flush surface with the main layer 204. In other words, the magnetic element 120 is positively connected to the main layer 204.

FIG. 17 is a schematic representation of an exemplary embodiment of a raw substrate unit 1200, as described, for example, in at least one of FIGS. 12 to 16. According to this exemplary embodiment, a contact surface 1100 is additionally arranged on the contact layer 204, to which bonding wires can be connected in a later step.

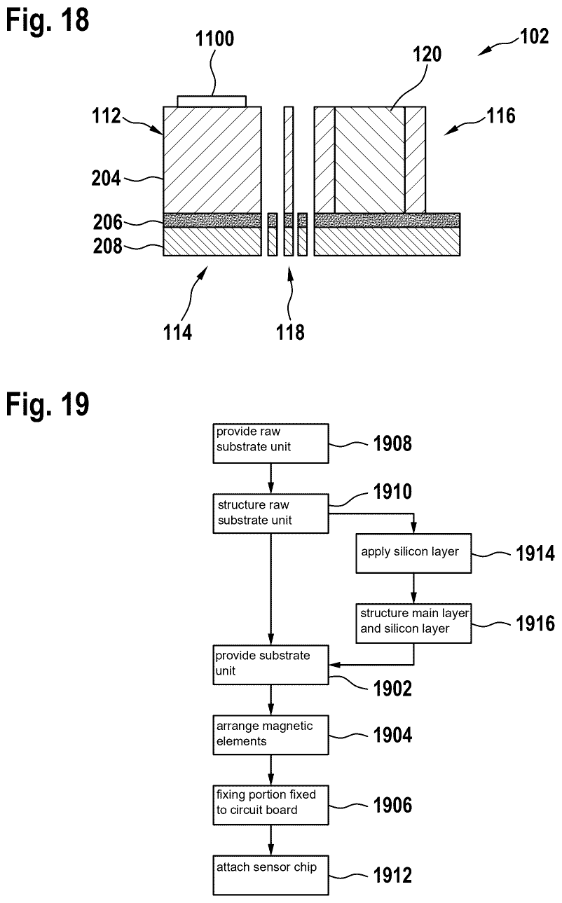

FIG. 18 is a schematic representation of an exemplary embodiment of a substrate unit 112, which corresponds, for example, to the substrate unit described in FIG. 11. Here, the substrate unit 112 was produced from a raw substrate unit, as described, for example, in FIGS. 12 to 17. The substrate unit 112 shown here differs from the raw substrate unit described in FIG. 17 only in such a way that in FIG. 18 the fixing portion 114, the motion portion 118 and the spring portion 118 are formed. This means that the oxide layer 206 and the silicon layer 208 form the spring portion 118. This further means that, according to this exemplary embodiment, the finished substrate unit 112 is shown.

FIG. 19 shows a flow chart of an exemplary embodiment of a method 1900 for producing a magnetic device, as described, for example, in at least one of FIGS. 1, 2 and/or 11. Here, the method 1900 comprises a step 1902 of providing a substrate unit, a plurality of magnetic elements and a circuit board that comprises a first conductor track circuit and a second conductor track circuit. The substrate unit comprises a fixing portion, a movable motion portion and a spring portion, wherein the fixing portion and the motion portion are connected to one another via the spring portion. The method 1900 further comprises a step 1904 of arranging the plurality of magnetic elements in the motion portion of the substrate unit, by way of example only, in a first row and in a second row running adjacent to the first row, wherein the magnetic elements of the first row are of the same polarity, and wherein the magnetic elements of the second row are of the same polarity and opposite polarity to the magnetic elements of the first row. In the step 1904 of arranging, the circuit board is also arranged adjacent to the substrate unit and opposite to the motion portion, wherein the first conductor track circuit runs, by way of example only, along the first row of magnetic elements and then runs back in the opposite direction along the second row of magnetic elements in order to effect a first force on the motion portion in the powered state. The second conductor track circuit runs, by way of example only, in a meandering pattern between the rows in order to effect a second force on the motion portion. In a step 1908 of fixing, the fixing portion is fixed to the circuit board.

According to this exemplary embodiment, in the step 1904 of arranging, the magnetic elements are arranged as a magnetic mass in the motion portion, in particular by means of a raking process. The method 1900 optionally further comprises a step 1908 of providing a raw substrate unit that comprises a main layer, an oxide layer and/or a silicon layer, and a step 1910 of structuring the raw substrate unit in order to produce the substrate unit prior to the step 1902 of providing the substrate unit, the plurality of magnetic elements and the circuit board.

In one exemplary embodiment, the structuring step 1910 comprises a first sub-step for jointly structuring the oxide layer and the silicon layer and a second sub-step for subsequently structuring the main layer in order to produce the substrate unit prior to the step 1902 of providing the substrate unit, the plurality of magnetic elements and the circuit board. In the step 1904 of arranging, the plurality of magnetic elements are then arranged in the structured main layer, and the circuit board is arranged adjacent to the substrate unit and opposite to the motion portion. Consequently, in the fixing step 1906, the fixing portion is fixed to the circuit board. Only optionally, the method 1900 comprises a step 1912 of attaching a sensor chip to a coupling point in the motion portion and at least one bonding wire for coupling the sensor chip to the circuit board.

Further optionally, in the step 1908, the raw substrate unit is provided, which comprises the main layer and the oxide layer. In step 1910 of structuring, the oxide layer is structured. Further optionally, the method 1900 comprises a step 1914 of applying a silicon layer after structuring the oxide layer and a further step 1916 of structuring the main layer and the silicon layer in order to produce the substrate unit prior to the step 1902 of providing the substrate unit, the plurality of magnetic elements and the circuit board.

FIG. 20 is a schematic representation of an exemplary embodiment of a magnet arrangement 2000 of the magnetic elements 120. For example, the magnet arrangement 2000 can be used instead of the magnet arrangement described with reference to FIG. 4.

For example only, the magnet arrangement 2000 comprises only a single row 122 in which the magnetic elements 120 are arranged.

More specifically, the plurality of magnetic elements 120 are arranged in at least one row 122 or only in a single row 122. The individual magnetic elements are alternately polarized. According to this exemplary embodiment, the first conductor track circuit 402 runs in a meandering pattern between the magnetic elements 120. The second conductor track circuit 404 also runs in a meandering pattern between the magnetic elements 120, but at least in the region of the plurality of magnetic elements 120 transversely or obliquely to the first conductor track circuit 402. With respect to the conductor track circuits 402, 404, the magnetic elements 120 according to this exemplary embodiment are arranged at an angle, for example diagonally, so that one corner of one magnetic element 120 faces another corner of a further of the magnetic elements 120.

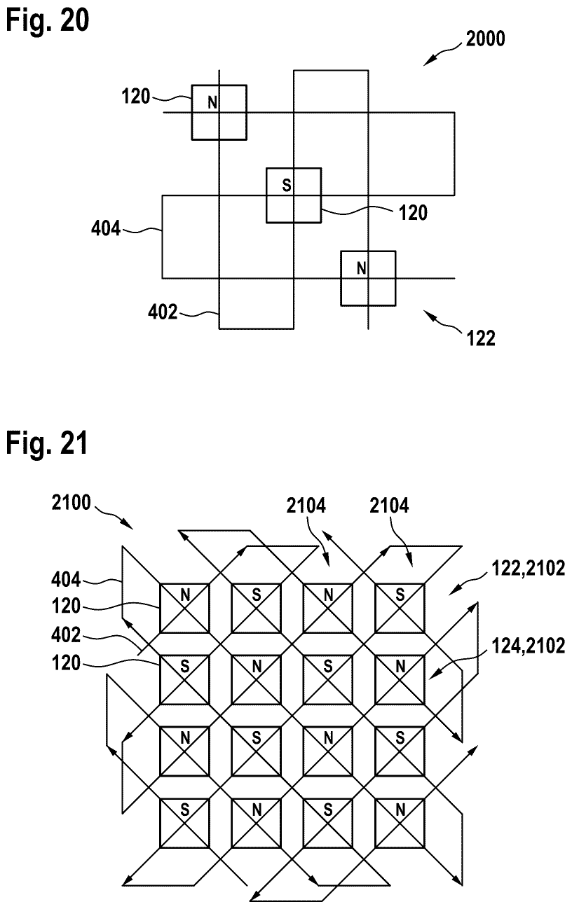

FIG. 21 is a schematic representation of an exemplary embodiment of a magnet arrangement 2100 of the magnetic elements 120. For example, the magnet arrangement 2100 can be used instead of the magnet arrangement described with reference to FIG. 4.

For example only, the magnet arrangement 2100 comprises a field of a plurality of rows 2102 and columns 2104 in which the magnetic elements 120 are arranged. According to one exemplary embodiment, the number of rows 2102 corresponds to the number of columns 2104. For example, the magnetic elements 120 are arranged in 4*4 rows 2102.

According to this exemplary embodiment, the plurality of magnetic elements 120 are arranged in a field of an alternating sequence of a first row 122 and a second row 124 running adjacent to the first row 122. The magnetic elements 120 of the first row 122 are alternately polarized. The magnetic elements 120 of the second row 124 are also alternately and additionally oppositely polarized to the magnetic elements 120 of the first row 122. According to this exemplary embodiment, portions of the first conductor track circuit 402 spanning the field run in one direction and in an opposite direction at an angle to the rows 122, 124, and portions of the second conductor track circuit 404 spanning the field run in one direction and in an opposite direction transversely or obliquely to the portions of the first conductor track circuit 402. In other words, the conductor track circuits 402, 404 run at an angle to the magnetic elements 120.

What is claimed is:

1. A magnetic device for a sensor device, the magnetic device comprising:
a substrate unit configured as a micromechanical electrical system (MEMS), which includes a fixing portion, a movable motion portion, and a spring portion, wherein the fixing portion and the motion portion are connected to one another via the spring portion, and wherein the motion portion includes a coupling point for coupling to a sensor chip of the sensor device;
a plurality of magnetic elements arranged in the motion portion; and
a circuit board arranged adjacent to the substrate unit, wherein the fixing portion is fixed to the circuit board, wherein the circuit board includes a first conductor track circuit and a second conductor track circuit opposite the motion portion, wherein the first conductor track circuit, in a powered state, generates a first magnetic field interacting with at least some of the plurality of magnetic elements to effect a translational deflection of the motion portion in a first direction, and wherein the second conductor track circuit, in a powered state, generates a second magnetic field interacting with at least some of the plurality of magnetic elements to effect a translational deflection of the motion portion in a second direction.

2. The magnetic device according to claim 1, wherein the plurality of magnetic elements are arranged in at least one first row and in at least one second row running adjacent to the first row, wherein the magnetic elements of the first row are equally polarized, and wherein the magnetic elements of the second row are equally and oppositely polarized to the magnetic elements of the first row, wherein the first conductor track circuit runs along the first row of the magnetic elements and runs in an opposite direction along the second row of the magnetic elements, wherein the second conductor track circuit runs in a meandering pattern between the first and second rows.

3. The magnetic device according to claim 1, wherein the plurality of magnetic elements are arranged in at least one row or only in a single row and are alternately polarized, wherein the first conductor track circuit runs in a meandering pattern between the magnetic elements, wherein the second conductor track circuit runs in a meandering pattern between the magnetic elements, and, at least in the region of the plurality of magnetic elements, transversely or obliquely to the first conductor track circuit.

4. The magnetic device according to claim 1, wherein the plurality of magnetic elements are arranged in a field including an alternating sequence of a first row and in a second row running adjacent to the first row, wherein the magnetic elements of the first row are alternately polarized, and wherein the magnetic elements of the second row are alternately and oppositely polarized to the magnetic elements of the first row, wherein portions of the first conductor track circuit spanning the field run at an angle to the first and second rows in one direction and an opposite direction, and portions of the second conductor track circuit spanning the field run transversely or obliquely to the portions of the first conductor track circuit in one direction and an opposite direction.

5. The magnetic device according to claim 1, wherein the first and second conductor track circuits each include a plurality of conductor tracks running parallel to one another, which are formed from copper.

6. The magnetic device according to claim 1, wherein the substrate unit includes a main layer, an oxide layer, and a silicon layer.

7. The magnetic device according to claim 6, wherein: (i) the main layer forms the spring portion, or (ii) the oxide layer and the silicon layer form the spring portion.

8. The magnetic device according to claim 1, further comprising a flux guiding element that is arranged on a side of the plurality of magnetic elements facing away from the circuit board.

9. A sensor device, comprising:
a magnetic device, including:
a substrate unit configured as a micromechanical electrical system (MEMS), which includes a fixing portion, a movable motion portion, and a spring portion, wherein the fixing portion and the motion portion are connected to one another via the spring portion, and wherein the motion portion includes a coupling point for coupling to a sensor chip of the sensor device,
a plurality of magnetic elements arranged in the motion portion, and
a circuit board arranged adjacent to the substrate unit, wherein the fixing portion is fixed to the circuit board, wherein the circuit board includes a first conductor track circuit and a second conductor track circuit opposite the motion portion, wherein the first conductor track circuit, in a powered state, generates a first magnetic field interacting with at least some of the plurality of magnetic elements to effect a translational deflection of the motion portion in a first direction, and wherein the second conductor track circuit, in a powered state, generates a second magnetic field interacting with at least some of the plurality of magnetic elements to effect a translational deflection of the motion portion in a second direction; and
the sensor chip coupled to the magnetic device at the coupling point.

10. The sensor device according to claim 9, further comprising:
a further magnetic device, including:
a further substrate unit configured as a MEMS, which includes a further fixing portion, a further movable motion portion, and a further spring portion, wherein the further fixing portion and the further motion portion are connected to one another via the further spring portion, and wherein the further motion portion includes a further coupling point,
a further plurality of magnetic elements arranged in the motion portion, and
a further circuit board arranged adjacent to the further substrate unit, wherein the further fixing portion is fixed to the further circuit board, wherein the further circuit board includes a further first conductor track circuit and a further second conductor track circuit opposite the motion portion, wherein the further first conductor track circuit, in a powered state, generates a further first magnetic field interacting with at least some of the further plurality of magnetic elements to effect a translational deflection of the further motion portion in a further first direction, and wherein the further second conductor track circuit, in a powered state, generates a further second magnetic field interacting with at least some of the further plurality of magnetic elements to effect a translational deflection of the further motion portion in a further second direction,
wherein the sensor chip is coupled to the further magnetic device at the further coupling point.

11. A method for producing a magnetic device, comprising the following steps:
Providing: (i) a substrate unit that includes a fixing portion, a movable motion portion, and a spring portion, wherein the fixing portion and the motion portion are connected to one another via the spring portion, (ii) a plurality of magnetic elements, and (iii) a circuit board that includes a first conductor track circuit and a second conductor track circuit;
arranging the plurality of magnetic elements in the motion portion of the substrate unit, and arranging the circuit board adjacent to the substrate unit and opposite to the motion portion; and
fixing the fixing portion to the circuit board.

12. The method according to claim 11, wherein, in the arranging step, the magnetic elements are arranged as a magnetic mass in the motion portion, by a raking process.

13. The method according to claim 11, further comprising the following steps:
providing a raw substrate unit that includes a main layer, an oxide layer, and/or a silicon layer; and
structuring the raw substrate unit to produce the substrate unit prior to the step of providing the substrate unit, the plurality of magnetic elements, and the circuit board.

14. The method according to claim 13, wherein the structuring includes a first sub-step for jointly structuring the oxide layer and the silicon layer, and a second sub-step for subsequently structuring the main layer to produce the substrate unit, prior to the step of providing the substrate unit, the plurality of magnetic elements, and the circuit board, wherein, in the step of arranging, the plurality of magnetic elements is arranged in the structured main layer, and the circuit board is arranged adjacent to the substrate unit and opposite to the motion portion, wherein in the step of fixing, the fixing portion is fixed to the circuit board, and the method further includes attaching a sensor chip to a coupling point in the motion portion and at least one bonding wire for coupling the sensor chip to the circuit board.

15. The method according to claim 13, wherein the provided raw substrate unit includes the main layer and the oxide layer, wherein, in the step of structuring, the oxide layer is structured, and wherein the method further comprises a step of applying a silicon layer after structuring the oxide layer, a further step of structuring the main layer and the silicon layer to produce the substrate unit prior to the step of providing the substrate unit, the plurality of magnetic elements, and the circuit board.
